(19) United States
(12) Patent Application Publication
(10) Pub. No.: US 2006/0285519 A1
(43) Pub. Date: Dec. 21, 2006

(54) Method and apparatus to facilitate handover key derivation

(76) Inventors: Vidya Narayanan, Schaumburg, IL (US); Madjid F. Nakhjiri, Palantine, IL (US); Narayanan Venkitaraman, Schaumburg, IL (US)

Correspondence Address: MOTOROLA, INC., 1303 EAST ALGONQUIN ROAD, IL01/3RD, SCHAUMBURG, IL, 60196, US

(21) Appl. No.: 11/153,683

(22) Filed: Jun. 15, 2005

(51) Int. Cl. H04Q 7/00; H04J 3/16

(52) U.S. Cl. 370/331; 370/469

(57) ABSTRACT

At least one candidate point-of-presence element to which at least one mobile node may be handed over from a first point-of-presence element is identified (201). In a preferred approach this occurs regardless of whether the point-of-presence elements differ from one another (for example, with respect to an enabling mobile node access technology, a service type, and/or a supported application to be handed over). A handover key is then derived (202) as corresponds at least to the identified point-of-presence element that use of that handover key is facilitated (203) to facilitate a possible handover of the mobile node from the first to the identified point-of-presence element. The handover key may also be used, if desired, to derive a pairwise handover key.

### TECHNICAL FIELD

This invention relates generally to communication networks having multiple potential points of presence for a given mobile node and more particularly to facilitating movement of a mobile node amongst such points of presence.

### BACKGROUND

Communication networks having multiple potential points of presence are known. For example, multiple Layer 2 points of presence are available when a communication network has a plurality of wireless access points (such as, but not limited to, 802.11-family access points as are known in the art). As another example, multiple Layer 3 points of presence become available when a communication network has a plurality of access routers as are also known in the art.

In many cases such networks are designed to accommodate mobile nodes that change their location from time to time (including during a present communication session). As a result, a given mobile node can change its point of presence with respect to such a network. For example, a change with respect to a Layer 2 point of presence will occur when the mobile node moves between Layer 2 points of attachment on a same Internet Protocol subnet while a change with respect to a Layer 3 point of presence (as well as with respect to a Layer 2 point of presence) will typically occur when the mobile node moves between different subnets.

In many cases it is desirable to effect a handover of such a mobile node from one point of presence to a next point of presence in conjunction with such moves (to persist, for example, an ongoing communication session). To perform such a handover, the mobile node and the point(s) of presence must usually mutually authenticate one another. To ensure system security this often requires use of a key that both elements can share which, in turn, often requires establishing one or more new keys.

To facilitate fast handovers, it is known to leverage the fact that the mobile node already usually knows the Internet Protocol/Medium Access Control (IP/MAC) address of the relevant point(s) of presence. For example, to effect a Layer 3 handover an Internet Protocol version 4 compatible mobile node may register with the new point of presence through an existing point of presence (before the actual handover) and thereby gain access to such information.

Proposals now exist suggesting use of Secure Neighbor Discovery protocol to establish handover keys in support of Mobile Internet Protocol version 6 notwithstanding, however, that at least some points of presence, such as access routers, have no present capability of supporting Secure Neighbor Discovery protocol to facilitate establishing handover keys in this manner. Furthermore, an additional problem entails a lack of a known mechanism to facilitate establishing a handover key prior to an actual handoff to thereby enable fast handoff solutions in a general manner (i.e., one that will apply to both Internet Protocol version 4 and Internet Protocol version 6 networks). Also, there is no known method to establish handover keys in advance to facilitate vertical handoffs (i.e., handoffs between access nodes belonging to different technologies—e.g., handoff from an 802.11 access point to an 802.16 base station).

### BRIEF DESCRIPTION OF THE DRAWINGS

The above needs are at least partially met through provision of the method and apparatus to facilitate handover key derivation described in the following detailed description, particularly when studied in conjunction with the drawings, wherein:

FIG. 1 comprises a block diagram as configured in accordance with various embodiments of the invention;

FIG. 2 comprises a flow diagram as configured in accordance with various embodiments of the invention;

FIG. 3 comprises a block diagram as configured in accordance with various embodiments of the invention; and

FIG. 4 comprises a call flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the arts will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one identifies at least one candidate point-of-presence element to which a given mobile node may be handed over from a first point-of-presence element. In a preferred approach, these two point-of-presence elements differ from one another with respect to at least one of an enabling mobile node access technology to be handed over, a service type to be handed over, and/or a supported application to be handed over. A preferred approach then supports deriving a handover key as corresponds to an identified one of the point-of-presence elements and facilitating use of that handover key to facilitate a possible handover of the mobile node from one such point-of-presence element to the other.

In a preferred approach these point-of-presence elements may comprise Layer 2 and/or Layer 3 operational entities and/or a network management entity (such as a mobility management device), an application entity, or the like. So configured, these teachings will readily support a handover notwithstanding that, for example, a service type to be handed over differs as between the origination and destination point-of-presence elements.

Also in a preferred approach, derivation of a handover key occurs as a function, at least in part, of at least one of a secret as is used by an Authentication, Authorization, and Accounting element (AAA) and as is shared between the mobile node and the AAA element, a nonce as is provided by at least one of the mobile node and the AAA element, a relatively unique identifier for at least one of the mobile node and one of the point-of-presence elements (such as, for example, the destination point-of-presence element), or the like. If desired, and again pursuant to a preferred approach, this handover key can then be employed to derive a pairwise handover key to be used to specifically facilitate the anticipated handover.

These teachings permit and facilitate handovers between point-of-presence elements having different capabilities and/or operational attributes and will further permit handovers at either or both of Layer 2 and Layer 3 connections. It will further be appreciated that these teachings are compatible for use with Internet Protocol version 4 and Internet Protocol version 6 elements and nodes (including systems containing a mixture of both kinds of elements and/or nodes) and further require no native ability to accommodate Secure Neighbor Discovery protocol. Those skilled in the art will also recognize that these solutions are relatively straightforward to implement and practical and cost effective to deploy.

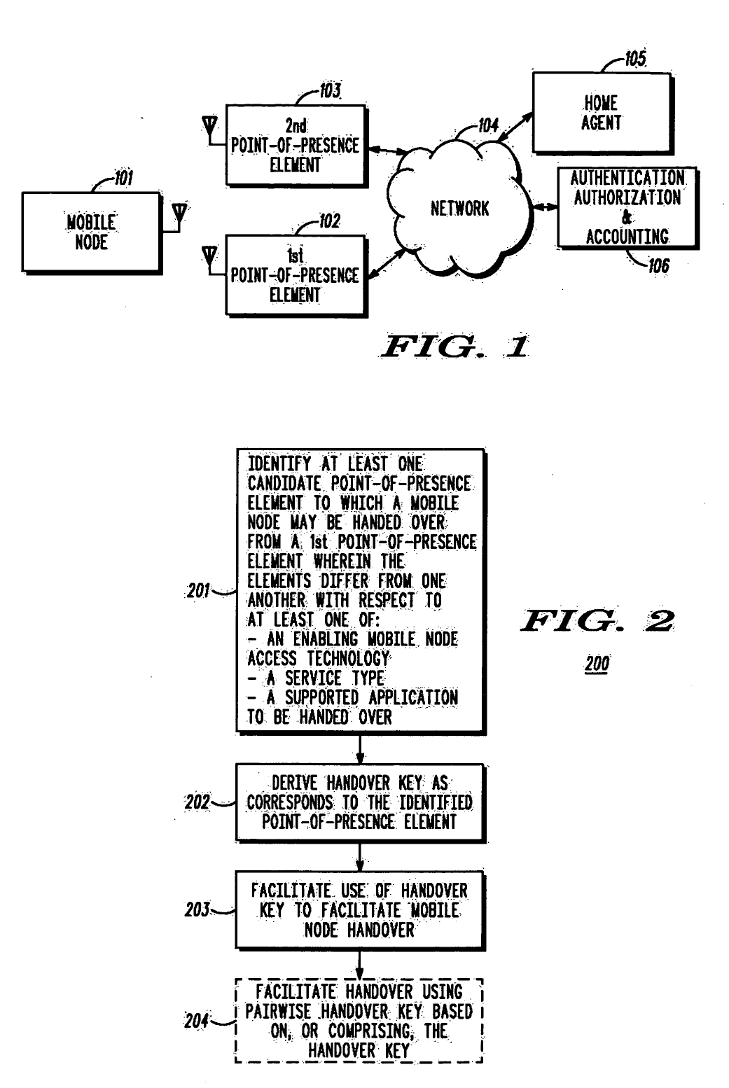

These and other benefits may become clearer upon making a thorough review and study of the following detailed description. Referring now to the drawings, and in particular to FIG. 1, it may be helpful to first briefly describe and characterize an illustrative context within which these teachings may be usefully employed. (Those skilled in the art will recognize that this exemplary context serves for the purpose of illustration only and does not constitute an exclusive or exhaustive contextual reference.) In this illustrative context a mobile node 101 is attached to a first point-of-presence element 102. These elements 101 and 102 communicate via a wireless connection using a carrier medium and protocol of choice. For these purposes the protocol may comprise an 802.11-family protocol but those skilled in the art will understand that essentially any communication protocol, either as presently exists or as is hereafter developed, may also serve. The point-of-presence element 102 may comprise a Layer 2 element (such as a wireless access point) and/or a Layer 3 element (such as an access router) as are known in the art.

In this illustrative context a second point-of-presence element 103 comprises another platform to which the mobile node may be handed over from the first point-of-presence element 102. As per these teachings, this second point-of-presence element 103 may be largely similar to the first point-of-presence element 102 or may differ substantially therefrom. More particularly, these elements 102 and 103 may differ from one another at least with respect to any one or more of an enabling mobile node access technology to be handed over (for example, these two elements may utilize differing communication protocols), a service type to be handed over (for example, mobility, multicast, and quality of service are all examples of services that may be handed off), a supported application to be handed over (for example, email, voice, and streaming video are all examples of applications that may be handed off), and so forth.

In this illustrative context these two point-of-presence elements 102 and 103 operably couple to a common network 104 comprising, in this example, an Internet Protocol-based network. Potentially pertinent to one or more examples presented below, a Home Agent 105 and/or an Authentication, Authorization, and Accounting (AAA) element 106 may also operably couple to the network 104, thereby making these latter elements 105 and 106 available to the point-of-presence elements 102 and 103. Pursuant to the teachings set forth below, it will be seen that such a mobile node 101 can now be handed over from one point-of-presence element to another notwithstanding significant differences between the operational capabilities of those elements and also while retaining and/or otherwise ensuring a satisfactory level of security.

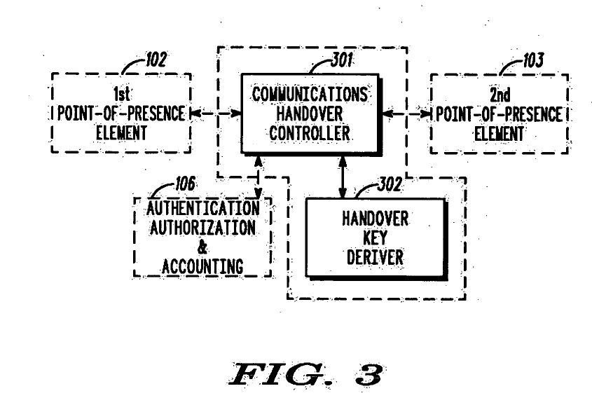

Referring now to FIG. 2, an illustrative process 200 provides for identification 201 of at least one candidate point-of-presence element to which at least one mobile node may be handed over from a first point-of-presence element to thereby provide at least one identified point-of-presence element. As per these teachings these elements can differ from one another with respect to at least one of an enabling mobile node access technology, a service type, and/or a supported application to be handed over as noted above.

This process 200 then provides for deriving 202 a handover key as corresponds to the at least identified point-of-presence element. This step can be accomplished using any of a wide variety of techniques. For example, the handover key can be derived as a function, at least in part, of at least one of:
a secret that is used by an Authentication, Authorization, and Accounting element and that is shared between that element and the mobile node (which secret may comprise, for example, a key as is presently and commonly provided and shared as just described);
a nonce as is provided by such an Authentication, Authorization, and Accounting element and/or the mobile node itself (wherein a nonce shall be understood to comprise a string of random (or pseudorandom) and/or non-repeating values that is typically coined and used for only a specific purpose such as key generation); and/or
a relatively unique identifier for the mobile node and/or the identified point-of-presence element (such as, but not limited to, a Medium Access Control (MAC) address, an Internet Protocol address (including both permanent and temporary addresses as are known in the art), and/or a Network Access Identifier, to name but a few);
   with other derivation criteria, parameters, and/or drivers being possible.

This process 200 then facilitates 203 use of that handover key to facilitate a possible handover of the at least one mobile node from the first point-of-presence element to the at least one identified point-of-presence element (with such key usage being otherwise relatively well understood by those skilled in the art and requiring no further elaboration here). Pursuant to one approach, if desired, such facilitation can comprise deriving a pairwise handover key (as is known in the art) to be used by the mobile node and the identified point-of-presence element.

In particular, this pairwise handover key can be derived as a function, at least in part, of the handover key itself. For additional security, if desired, this pairwise handover key can be further derived as a function of other content such as, but not limited to, a relatively unique identifier for the identified point-of-presence element, a service type as characterizes the identified point-of-presence element, or the like. As yet another example, the earlier derived handover can itself serve as the pairwise handover key if so desired. When deriving a pairwise handover key as described, this process 200 can then optionally but preferably provide for facilitating 204 the desired handover through use of that pairwise key.

So configured, it will be understood and appreciated that effective handovers of a mobile node from one point-of-presence element to another (wherein the latter may differ in significant ways from the former in ways that were previously highly relevant to handover possibilities) while nevertheless maintaining a high degree of security.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform will now be provided. An apparatus 300 configured and arranged to facilitate the teachings presented above can preferably comprise a communication handover controller 301 that operably couples to a handover key deriver 302. The communication handover controller 301 operably couples to at least two point-of-presence elements 102 and 103 wherein these two point-of-presence elements 102 and 103 may differ from one another in manners as were previously described above and which include, but are not limited to, their access technology, their service type (or types), and/or their supported application (or applications).

The handover key deriver 302 preferably has a handover key output that provides a handover key to the communications handover controller 301 that is suitable to use when handing over a mobile node (not shown) from the first point-of-presence element 102 to the second point-of-presence element 103. If desired, the handover key deriver 302 can further comprise an input that operably couples to an Authentication, Authorization, and Accounting element 106 to thereby receive a network authentication key as is used by the latter and as is shared between the latter and the corresponding mobile node (and/or, if desired, other derivation content such as a nonce). Other possibilities exist as well including those noted above (where handover key derivation is based, at least in part, on a nonce as is provided by the mobile node and/or a relatively unique identifier as corresponds to the mobile node and/or at least one of the point-of-presence elements 102 and 103).

So configured, the communications handover controller 301 can identify at least one candidate point-of-presence element (such as a wireless access point or an access router) to which at least one corresponding mobile node may be handed over from a first point-of-presence element (wherein the elements differ from one another in significant ways) and then facilitate use of a handover key as is derived by the handover key deriver 302 to facilitate a possible handover of that mobile node to a particular candidate point-of-presence element. And, in a preferred approach, the handover key deriver 302 (and/or the communications handover controller 301 itself) can further derive a pairwise handover key (as a function, for example, of a relatively unique identifier for the target point-of-presence element) as a function, at least in part, of that handover key.

Those skilled in the art will recognize and acknowledge the logical (as versus physical) nature of the apparatus 300 described in FIG. 3. Accordingly, it will be understood that this apparatus 300 can comprise a discrete physical entity as suggested by the figure but can also comprise, if desired, an integral part of one or more of the point-of-presence elements themselves and/or another entity such as, but not limited to, the Authentication, Authorization, and Accounting element 106 shown. It will also be understood that this apparatus 300 can comprise a centralized entity or can be physically distributed over multiple elements if desired and in accordance with generally well-understood prior art technique in this regard.

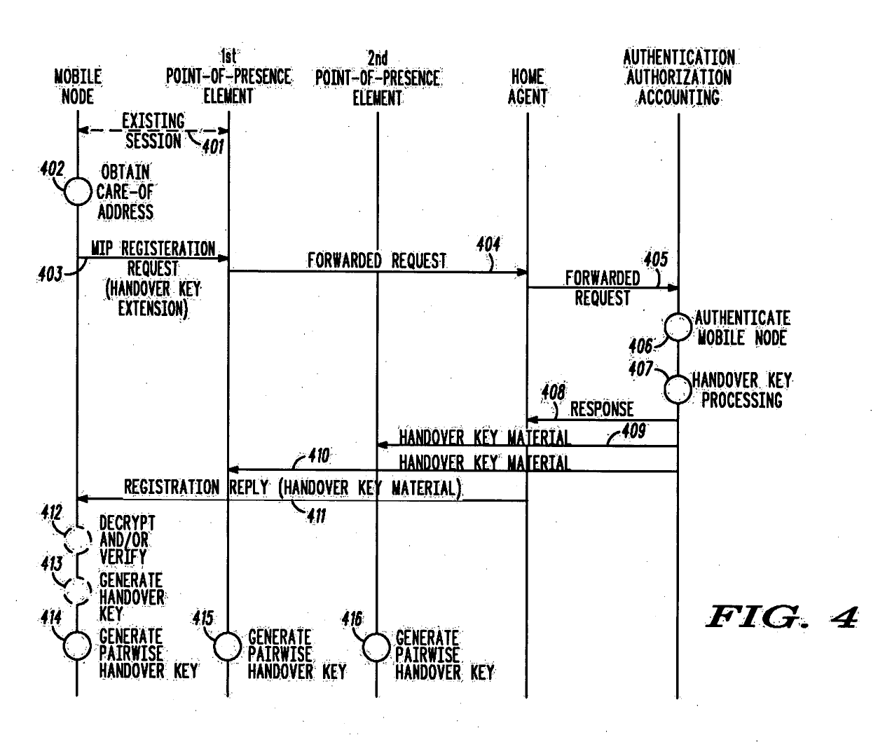

Referring now to FIG. 4, an illustrative scenario that employs at least some of these teachings will be described. In this example, which presumes a previously established communication session 401 wherein a mobile node has become attached to a first point-of-presence element (wherein the attachment context may comprise a Layer 2 and/or a Layer 3 attachment), the mobile node begins to facilitate a possible handover by first obtaining a care-of address (such as a Mobile Internet Protocol care-of address as is known in the art) from or via, for example, its existing point-of-presence element in accordance with presently understood practice.

The mobile node then transmits, in this example, a Mobile Internet Protocol registration request 403 and 404 via the first point-of-presence element to a Home Agent, which registration request comprises, as per these teachings, an extension comprising a handover key extension. (In another embodiment this message could comprise, for example, an Extensible Authentication Protocol message.) This handover key extension can vary with the needs and/or requirements of a given application setting. A useful example comprises, but is not limited to, a mobile node nonce. If desired, this extension content can itself be authenticated by or even encrypted through use of a key the mobile node shares a priori with an Authentication, Authorization, and Accounting element as is otherwise provided by present practice.

The Home Agent forwards a registration request message 405 to a corresponding Authentication, Authorization, and Accounting element. The latter then authenticates 406 the mobile node (using, for example, the authentication content such as the above-mentioned shared key) and, presuming successful authentication and as per this particular illustrative example, itself processes 407 the handover key. Depending upon configuration details as may be selected by a given system administrator or designer, this handover key can be specific to a particular point-of-presence element (such as the handover target) or can be generalized to encompass a larger group (such as, for example, a group of candidate point-of-presence elements to which the mobile node may be presently handed over).

This Authentication, Authorization, and Accounting element then sends a response 408 to the Home Agent, which response may also (either as may be required by the system or as may be instructed or otherwise requested by the mobile node) include a self-sourced nonce and/or the derived handover key (in a preferred approach this response, or at least the nonce/key portion thereof, will also be authenticated and/or encrypted using the mobile node-AAA key as was mentioned above). The Authentication, Authorization, and Accounting element also transmits handover key material 409 and 410 to the appropriate point-of-presence elements. This handover key material may comprise the derived handover key itself or may comprise information that the recipients can employ to themselves then derive the handover key. (For example, when the handover key is derived as a function of the Internet Protocol address for a specific point-of-presence element, the AAA may send the derived key to the Home Agent as described above but only send information to the specific point-of-presence element sufficient to permit the latter to itself derive the handover key using its own Internet Protocol address which is of course known to itself.)

To continue this example, the Home Agent then processes the response 408 from the Authentication, Authorization, and Accounting element and forms a registration reply 411 that is transmitted to the mobile node. In a preferred approach this registration reply 411 includes the aforementioned handover key material as was earlier provided by the Authentication, Authorization, and Accounting element.

In a preferred approach the mobile node decrypts (using the aforementioned AAA-mobile node key) and/or verifies 412 at least the handover key contents of the registration reply 411. When the handover key contents do not constitute the handover key itself, the mobile node employs the handover key contents to generate 413 the appropriate handover key.

If desired, and pursuant to a preferred approach, the mobile node (as well as the one or more intended point-of-presence element participants) then generates a unique pairwise handover key 414, 415, and 416 using the previously derived handover key and such other parameters as may be desired. That pairwise handover key (or only the handover key in an embodiment that does not make use of the pairwise handover key) is then used (not shown) to facilitate a handover of the mobile node from one point-of-presence element to another in a secure, authenticated, and timely manner notwithstanding numerous categories of difference as may exist as between those point-of-presence elements.

The description provided above makes reference to derivation of both handover keys and pairwise handover keys. Such keys can be derived in any of a wide variety of ways as will be recognized and understood by those skilled in the art. From a general point of view, the handover key can be computed as a pseudorandom function based on such parameters as one or more of the corresponding mobile node-AAA key, a mobile node-AAA nonce, an AAA nonce, an identifier for the mobile node (such as an Internet Protocol address), an identifier for the point-of-presence element (such as a Medium Access Control address, a Network Access identifier, and so forth), and/or any other parameter of interest as may be available for use in a given application setting.

When using a mobile node-AAA nonce, the latter will typically be generated by the mobile node and sent to the Authentication, Authorization, and Accounting element. In a preferred approach this nonce will have a specific corresponding lifetime during which the AAA can use the nonce multiple times for key derivation purposes notwithstanding prior art practices that favor single use nonces. Single use nonces can of course be employed but this will likely require a mobile node to communicate with the Authentication, Authorization, and Accounting element at every impending handoff and this, in turn, may tend to increase handoff latency.

Using the key derivation approach described above, if desired, the mobile node and the Authentication, Authorization, and Accounting element can each independently derive an identical key by exchanging the cryptographically generated nonce values.

From a general point of view, the above mentioned pairwise handover key can be computed as a pseudorandom function based on such parameters as one or more of the aforementioned handover key, a corresponding mobile node-AAA nonce, a point-of-presence element nonce, and/or any other parameter of interest as may be available for use in a given application setting.

Those skilled in the art will recognize the relative ease by which these teachings may be applied across a wide range of implementing technologies. As a general principle these teachings are usable in essentially any mobility scenario where a mobile node changes its point of attachment from time to time. In particular, these embodiments are applicable regardless of whether the mobile node switches attachment with respect to an access router, a Mobile Internet Protocol Foreign Agent, a Wireless Local Area Network access point, a cellular base station, a Virtual Private Network gateway, and so forth. It will further be appreciated that these teachings are also applicable in settings where the mobile node interacts with a mobile entity that serves a mobility region locally and needs to send authenticated control messages. Particular examples include, but are not limited to, quality of service managers, Session Initiation Protocol servers, location managers, multicast proxies, and so forth.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, when using an identifier for a point-of-presence element as a handover key derivation parameter, the identifier itself can contain a field that identifies the device type that characterizes the point-of-presence element. For example, the device type can differentiate between 802.11-family platforms and 802.16-family platforms. This field could aid, for example, an Authentication, Authorization, and Accounting element by permitting the latter to take specific access technology considerations into account when deriving a particular handover key. As another example, the point-of-presence element identifier could also contain a public key for that point-of-presence element that could then be used to authenticate the entity.

Those skilled in the art will further understand and appreciate that where a mobile node sends information regarding interface types, service types, or application types to the handover key deriver (directly or indirectly—for example, through a Home Agent or an AAA server), the handover key can be derived by taking that information into account. For instance, even though the network may have 802.11, 802.16, and ethernet points of presence, the mobile node may only have 802.11 and ethernet interfaces. These teachings, so employed, will help the handover key deriver to determine which points of presence to derive the handover keys for.

We claim:

1. A method comprising:
identifying at least one candidate point-of-presence element to which at least one mobile node may be handed over from a first point-of-presence element to provide at least one identified point-of-presence element, wherein the at least one identified point-of-presence element differs from the first point-of-presence element with respect to at least one of:
an enabling mobile node access technology to be handed over;
a service type to be handed over;
a supported application to be handed over;
deriving a handover key as corresponds to the at least one identified point-of-presence element;
facilitating use of the handover key to facilitate a possible handover of the at least one mobile node from the first point-of-presence element to the at least one identified point-of-presence element.

2. The method of claim 1 wherein at least one of the point-of-presence elements comprises at least one of:
an entity operating at Layer2;
an entity operating at Layer3;
a network management entity such as a mobility management device;
an application entity.

3. The method of claim 1 wherein the first point-of-presence element differs from the at least one identified point-of-presence element with respect to the service type to be handed over, in that the service type of one of the first point-of-presence element and the at least one identified point-of-presence element comprises a Layer2 service type element and the service type of another of the first point-of-presence element and the at least one identified point-of-presence element comprises a Layer3 service type element.

4. The method of claim 1 wherein deriving a handover key as corresponds to the at least one identified point-of-presence element comprises deriving the handover key as a function, at least in part, of at least one of:
a secret as used by an Authentication, Authorization, and Accounting (AAA) element that is shared between the AAA element and the at least one mobile node;
a nonce as is provided by the AAA element;
a nonce as is provided by the at least one mobile node;
a relatively unique identifier for the at least one mobile node;
a relatively unique identifier for the identified point-of-presence element.

5. The method of claim 4 wherein the relatively unique identifier for the identified point-of-presence element comprises at least one of:
a Medium Access Control (MAC) address;
an Internet Protocol address;
a Network Access Identifier.

6. The method of claim 1 wherein facilitating use of the handover key to facilitate a possible handover of the at least one mobile node from the first point-of-presence element to the at least one identified point-of-presence element further comprises deriving a pairwise handover key to be used by the at least one mobile node and the identified point-of-presence element as a function, at least in part, of the handover key.

7. The method of claim 6 wherein deriving a pairwise handover key further comprises deriving the pairwise handover key as a function, at least in part, of:
a relatively unique identifier for the identified point-of-presence element; and
a service type as characterizes the identified point-of-presence element.

8. The method of claim 1 further comprising:
facilitating the handover of the at least one mobile node from the first point-of-presence element to the at least one identified point-of-presence element using a pairwise handover key that is based, at least in part, on the handover key.

9. The method of claim 1 further comprising:
facilitating the handover of the at least one mobile node from the first point-of-presence element to the at least one identified point-of-presence element using a pairwise handover key that comprises the handover key.

10. An apparatus comprising:
a communications handover controller operably coupled to at least two point-of-presence elements, wherein the at least two point-of-presence elements differ from one another with respect to at least one of:
their access technology;
their service type;
their supported application;
a handover key deriver operably coupled to the communications handover controller and having a handover key output that provides a handover key suitable to use when handing over a mobile node from a first one of the at least two point-of-presence elements to a second one of the at least two point-of-presence elements.

11. The apparatus of claim 10 wherein the handover key deriver has in input operably coupled to receive at least one of:
a network authentication key as used by an Authentication, Authorization, and Accounting (AAA) element that is shared between the AAA element and the mobile node;
a nonce as is provided by the AAA element;
a nonce as is provided by the mobile node;
a relatively unique identifier for the mobile node;
a relatively unique identifier for at least one of the point-of-presence elements;
those types of points-of-presence elements that the mobile node is capable of coupling with;
such that the handover key is derived, at least in part, as a function of the input.

12. The apparatus of claim 10 wherein the handover key deriver further comprises means for responding to an anticipated but-not-yet-existing need for a handover of the mobile node from the first one of the at least two point-of-presence elements to the second one of the at least two point-of-presence elements.

13. The apparatus of claim 10 wherein the apparatus comprises at least one of a wireless access point, a wireless access router, and an authentication server.

14. An apparatus comprising:
means for identifying at least one candidate point-of-presence element to which at least one corresponding mobile node may be handed over from a first point-of-presence element to provide at least one identified point-of-presence element, wherein the at least one identified point-of-presence element differs from the first point-of-presence element with respect to at least one of:
an access technology to be handed over to;
a service type to be handed over;
a supported application to be handed over;
means for deriving a handover key as corresponds to the at least one identified point-of-presence element;
means for facilitating use of the handover key to facilitate a possible handover of the at least one mobile node from the first point-of-presence element to the at least one identified point-of-presence element.

15. The apparatus of claim 14 wherein the at least one candidate point-of-presence element comprises at least one of:
a wireless access point;
an access router.

16. The apparatus of claim 14 wherein:
the first point-of-presence element differs from the at least one identified point-of-presence element with respect to the service type to be handed over, in that the service type of one of the first point-of-presence element and the at least one identified point-of-presence element comprises a Layer2 service type element and the service type of another of the first point-of-presence element and the at least one identified point-of-presence element comprises a Layer3 service type element; and
the means for deriving a handover key as corresponds to the at least one identified point-of-presence element further comprises means for deriving the handover key as a function, at least in part, of at least one of:
a network authentication key as used by an Authentication, Authorization, and Accounting (AAA) element that is shared between the AAA element and the at least one mobile node;
a nonce as is provided by the AAA element;
a nonce as is shared between the AAA element and the at least one mobile node;
a relatively unique identifier for the at least one mobile node;
a relatively unique identifier for the identified point-of-presence element.

17. The apparatus of claim 14 wherein the means for facilitating use of the handover key to facilitate a possible handover of the at least one mobile node from the first point-of-presence element to the at least one identified point-of-presence element further comprises means for deriving a pairwise handover key to be used by the at least one mobile node and the identified point-of-presence element as a function, at least in part, of the handover key.

18. The apparatus of claim 17 wherein the means for deriving a pairwise handover key further comprises means for deriving the pairwise handover key as a function, at least in part, of a relatively unique identifier for the identified point-of-presence element.
